(19) United States
(12) Patent Application Publication
(10) Pub. No.: US 2018/0100618 A1
(43) Pub. Date: Apr. 12, 2018

(54) SCREW CLAMP HAVING MOVABLE FOLLOWER

(71) Applicant: Oxti Corporation, Taipei (TW)

(72) Inventor: Chih Feng HO, Taipei (TW)

(21) Appl. No.: 15/291,096

(22) Filed: Oct. 12, 2016

(51) Int. Cl. F16M 13/02; F16B 2/12

(52) U.S. Cl. CPC F16M 13/022; F16B 2/12

(57) ABSTRACT

A screw clamp includes a clamping device having a follower and a coupling extension extended downwardly from the follower, and one or more anchoring elements disposed below the follower and each pivotally attached to the coupling extension with a pivot axle for engaging with the table plate, the follower includes a screw hole, the anchoring element is pivotable relative to the coupling extension between a working position parallel to the coupling extension and a folded position perpendicular to the coupling extension, and a fastener is engaged with the screw hole of the follower for moving the follower relative to the table plate and to be secured to the table plate with the fastener.

### BACKGROUND OF THE INVENTION

### 1. Field of the Invention

The present invention relates to a screw clamp or carrier or support device, and more particularly to a screw clamp including an improved structure arranged for allowing the screw clamp to be easily actuated or operated by the user, and including an anchoring board attachable to a carrier member for allowing the carrier member to be easily engaged through a tiny space beside an edge portion of a table plate.

### 2. Description of the Prior Art

Typical screw clamps comprise a C-shaped clamp body, and a bolt or screw threaded and attached or mounted to one end of the clamp body and rotatable and movable or adjustable toward the other end of the clamp body for attaching or mounting or securing or clamping the clamp body onto various supporting members or tables.

For example, U.S. Pat. No. 4,494,177 to Matthews, U.S. Pat. No. 4,569,498 to Ermanski, U.S. Pat. No. 4,582,307 to Wang, U.S. Pat. No. 4,627,604 to Choi, U.S. Pat. No. 4,736,878 to Rasor, U.S. Pat. No. 4,874,155 to Goul, U.S. Pat. No. 4,921,234 to Peterson, U.S. Pat. No. 5,180,220 to Van Kalsbeek, U.S. Pat. No. 5,370,570 to Harris, U.S. Pat. No. 5,423,525 to Spainhower, U.S. Pat. No. 5,765,902 to Love, U.S. Pat. No. 5,833,180 to Baranowski, U.S. Pat. No. 5,833,189 to Rossman et al., U.S. Pat. No. 6,032,939 to Chen, U.S. Pat. No. 6,086,228 to McGowan et al., U.S. Pat. No. 6,375,140 to Shen, U.S. Pat. No. 6,394,403 to Hung, U.S. Pat. No. 6,478,275 to Huang, U.S. Pat. No. 7,104,673 to Yu, and U.S. Pat. No. 7,121,516 to Koh disclose several of the typical screw clamps, clamp bases or the like each also comprising a bolt or screw threaded and attached or mounted to one end of the clamp body for clamping onto various supporting members or tables and for supporting the other members or objects, such as the keyboards, the monitors or the like.

However, the clamp body includes a solid and spatial structure that may not be folded to the compact folding structure and that may not be easily and quickly attached or mounted or secured or clamped onto various supporting members or tables. The users have to bend or squat lower than the supporting members or tables for actuating or operating or rotating or driving the screw or bolt to attach the clamp body onto the supporting members or tables such that the typical screw clamps may not be easily actuated or operated by the user.

The present invention has arisen to mitigate and/or obviate the afore-described disadvantages of the conventional screw clamps or carriers or support devices.

### SUMMARY OF THE INVENTION

The primary objective of the present invention is to provide a screw clamp including an improved structure arranged for allowing the screw clamp or carrier or support device to be easily actuated or operated by the user.

The other objective of the present invention is to provide a screw clamp including an anchoring board attachable to a carrier member for allowing the carrier member to be easily and quickly and readily engaged through a tiny space beside an edge portion of a table plate.

In accordance with one aspect of the invention, there is provided a screw clamp for attaching to a table plate, comprising a clamping device including a follower to be supported on the table plate, a coupling extension extended downwardly from the follower, and one or more anchoring elements provided below the follower and each pivotally attached to the coupling extension of the follower with a pivot axle for engaging with the table plate, the follower including a screw hole formed therein, the anchoring elements are pivotable relative to the coupling extension between a first position where the anchoring element is parallel to the coupling extension, and a second position where the anchoring element is perpendicular to the coupling extension, and a fastener is engaged with the screw hole of the follower for moving the follower up and down relative to the table plate when the fastener is rotated relative to the follower, for allowing the follower to be secured to the table plate with the fastener, and for allowing the screw clamp to be easily actuated or operated by the user.

The anchoring elements each include a tilted lower surface inclined relative to the coupling extension and the pivot axle for allowing the anchoring elements to be pivoted or rotated relative to the coupling extension to the first or working position where the anchoring elements are in line with or parallel to the coupling extension, with or by the table plate when the anchoring elements and the coupling extension are engaged through the tiny space that is formed or provided beside or between the edge portion of the table plate and a wall member. The anchoring element includes a flat upper surface perpendicular to the coupling extension and parallel to the follower and the table plate.

A spring biasing member may further be provided and engaged with the coupling extension and the anchoring element for biasing and forcing the anchoring element to the second position where the anchoring element is perpendicular to the coupling extension and for allowing the anchoring elements to be pivoted or rotated relative to the coupling extension to the first or working position where the anchoring elements are parallel to the coupling extension.

A carrier member may further be provided and includes a compartment formed therein, the carrier member including a through hole formed in the carrier member and communicating with the compartment of the carrier member and aligned with the screw hole of the follower for engaging with the fastener, and the carrier member including an attachment mechanism for attaching a facility, such as keyboard, monitor, displayer or the like.

The compartment of the carrier member includes a non-circular cross section and opened downwardly and rearwardly, and the follower includes a non-circular cross section for being guided and limited to slide up and down relative to the compartment of the carrier member and for preventing the follower from being rotated relative to the carrier member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a screw clamp in accordance with the present invention;

FIG. 2 is a perspective view of the screw clamp;

FIG. 3 is another perspective view similar to FIG. 2, illustrating the operation of the screw clamp;

FIG. 4 is an enlarged partial perspective view of the screw clamp;

FIGS. 5, 6 are perspective views illustrating the operation of the screw clamp; and

FIGS. 7, 8 are side plan schematic views illustrating the operation of the screw clamp.

### DETAILED DESCRIPTION OF THE PREFERRED EMBODIMENT

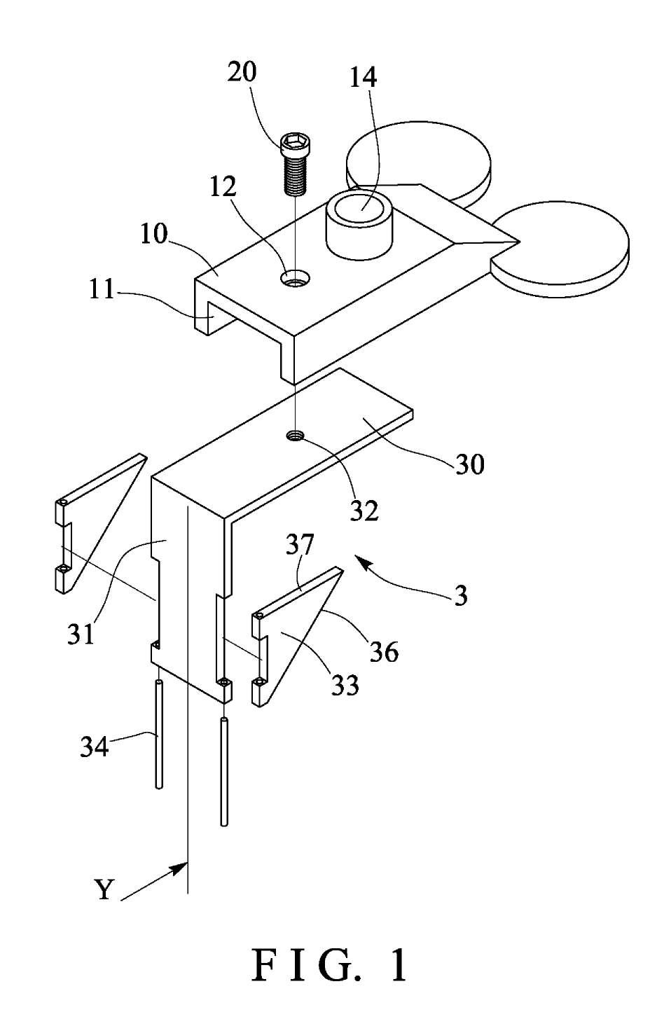

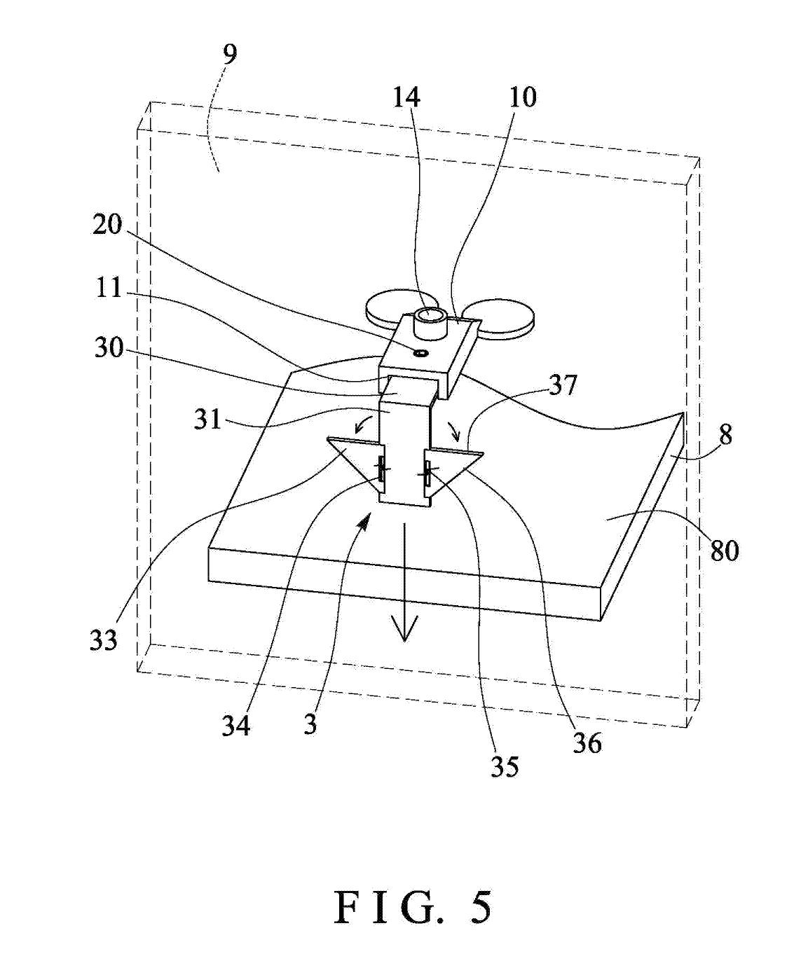

Referring to the drawings, and initially to FIGS. 1-4, a screw clamp in accordance with the present invention comprises a housing or receptacle or block or turret or seat or carrier or support plate or member 10 arranged to be engaged onto and supported on the upper surface 80 of the table plate 8 (FIGS. 5-8), the carrier member 10 includes a chamber or compartment 11 formed therein and having a non-circular cross section and opened downwardly and rearwardly, and includes a through hole 12 formed therein (FIG. 1) and communicating with the compartment 11 of the carrier member 10 for slidably or pivotally or rotatably receiving or engaging with a bolt or screw or fastener 20, and includes an aperture or orifice or opening or attachment mechanism 14 provided therein for attaching or mounting an object or apparatus or facility (not illustrated), such as keyboard, monitor, displayer or the like, to the carrier member 10.

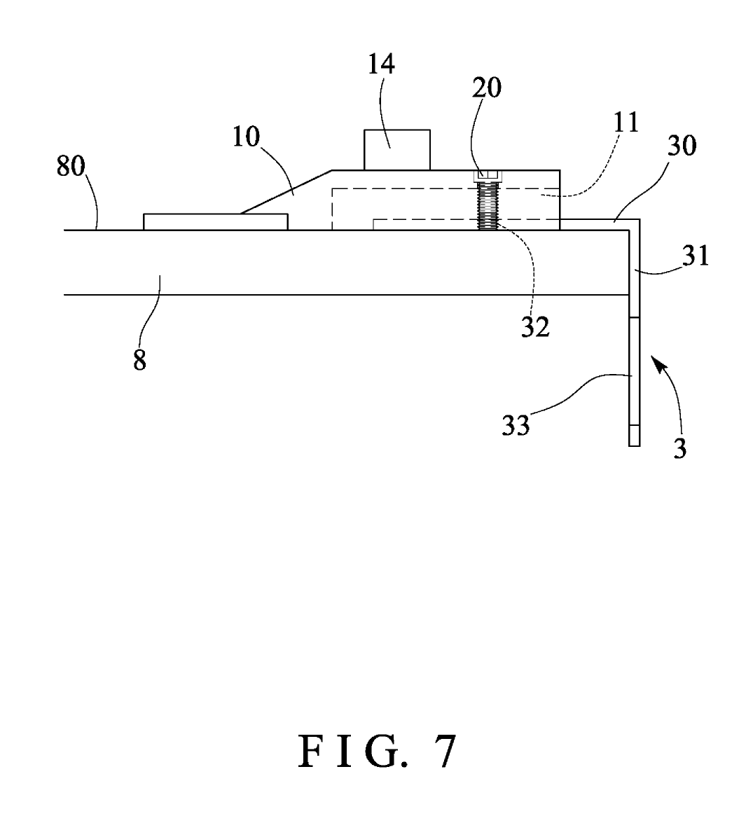

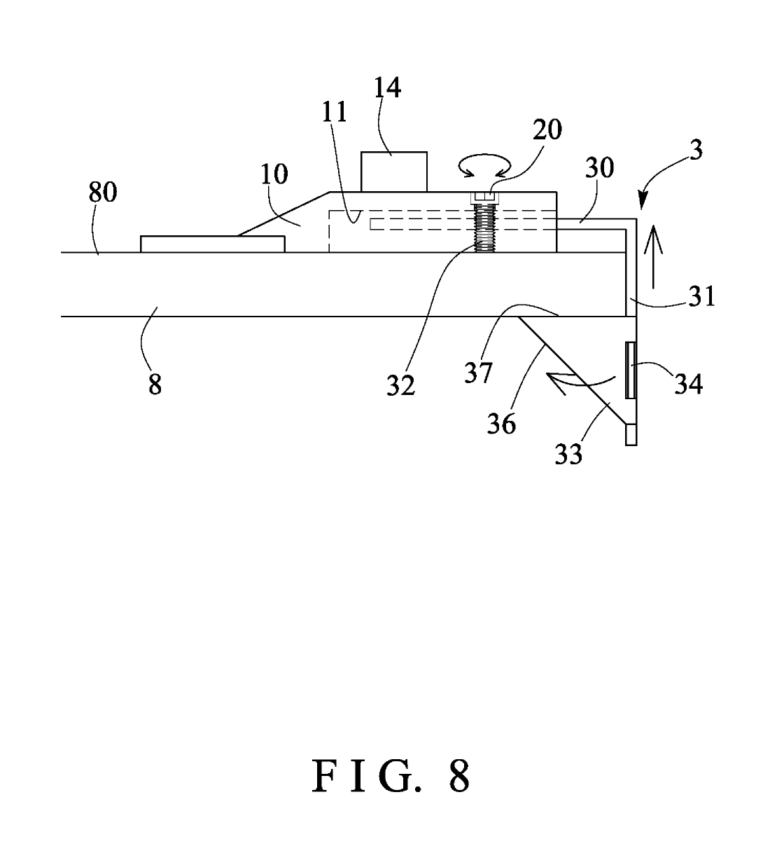

A clamping device 3 includes a base plate or sliding member or follower 30 slidably received or engaged in the compartment 11 of the carrier member 10 (FIGS. 7, 8) and having a non-circular cross section or outer peripheral structure or configuration or contour similar to that of the compartment 11 of the carrier member 10 for being guided and limited to slide up and down along or relative to the compartment 11 of the carrier member 10 and for preventing the follower 30 from being pivoted or rotated or moved sidewise relative to the carrier member 10, the follower 30 includes a screw hole 32 formed therein (FIGS. 1, 7-8) and aligned with the through hole 12 of the carrier member 10 for threading or engaging with the fastener 20 and for allowing the follower 30 to be actuated or operated to slide or move up and down along or relative to the compartment 11 of the carrier member 10 when the fastener 20 is selectively rotated or driven by a driver tool (not illustrated), and thus for guiding and moving the follower 30 to slide or move up and down relative to the upper surface 80 of the table plate 8 (FIGS. 7-8).

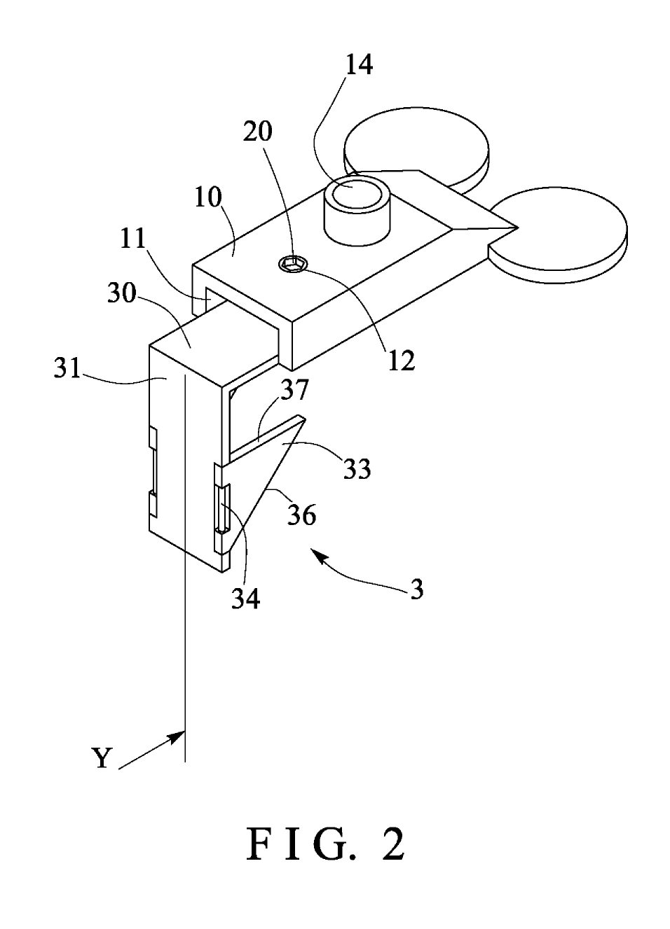

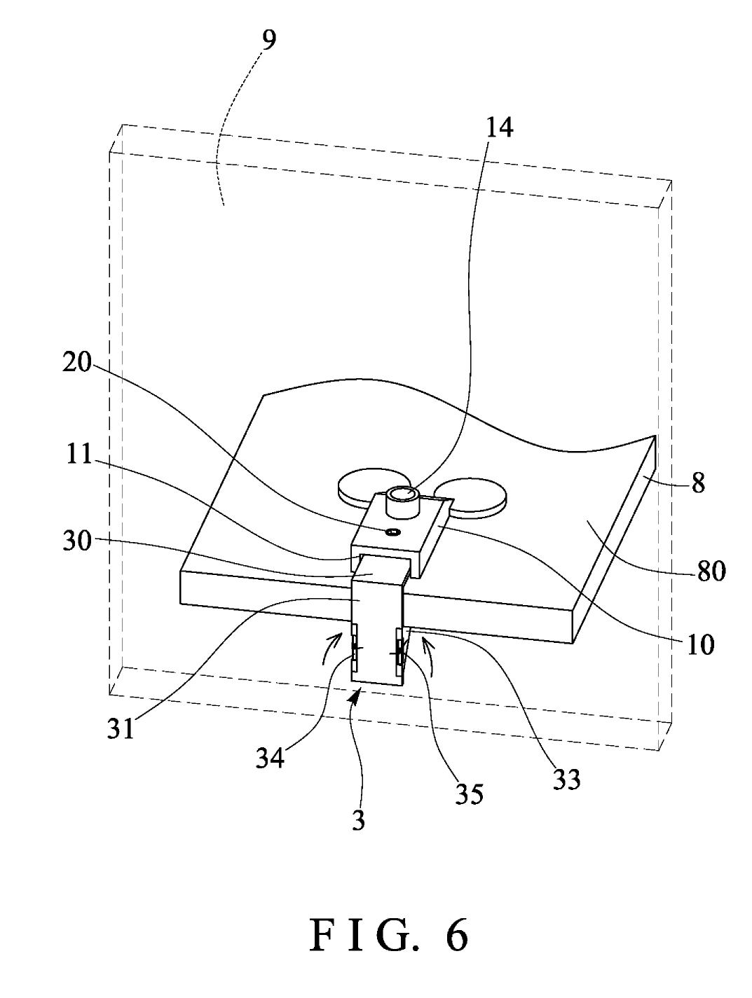

The follower 30 further includes an anchoring or hanger or coupling plate or extension 31 extended downwardly therefrom and perpendicular to the follower 30 and preferably or selectively disposed or located outside the compartment 11 of the carrier member 10 (FIGS. 2-8), and arranged for allowing the coupling extension 31 of the follower 30 to be easily and quickly engaged through a tiny space that is formed or provided beside an edge portion of the table plate 8 or between the edge portion of the table plate 8 and a wall member 9 (FIGS. 5, 6) or the like, and to be easily and quickly attached and mounted to and engaged onto the table plate 8. The follower 30 further includes one or more (such as two) guiding or anchoring boards or elements 33 pivotally or rotatably attached or mounted or secured to the coupling extension 31 of the follower 30 with pivot axles 34 respectively and located below the follower 30.

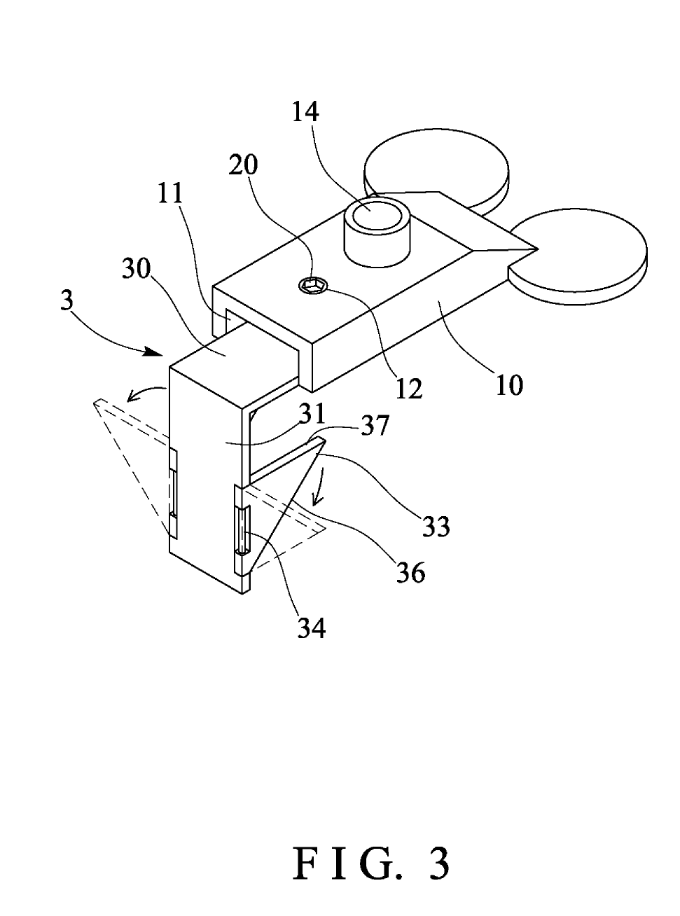

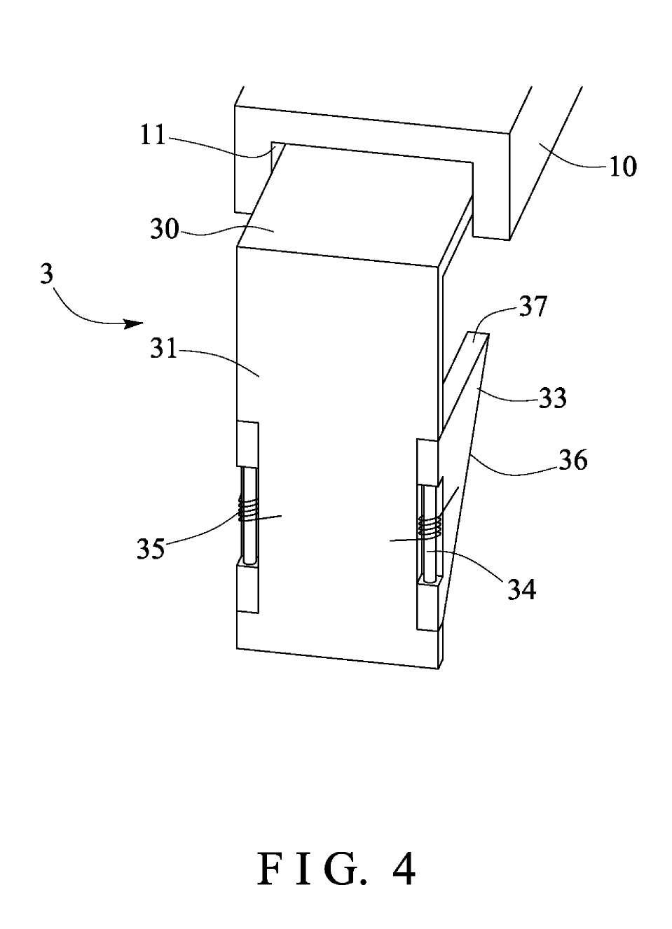

For example, the pivot axles 34 are parallel to the longitudinal axis Y of the coupling extension 31 of the follower 30 for allowing the anchoring elements 33 to be pivoted or rotated relative to the coupling extension 31 (FIG. 3) between a first or working position where the anchoring elements 33 are in line with or parallel to the coupling extension 31 (FIGS. 5, 7), and a second or folding position where the anchoring elements 33 are perpendicular to the coupling extension 31 (FIGS. 2, 4, 6, 8) and arranged and located below the table plate 8, and where the table plate 8 may be located or engaged between the follower 30 and the anchoring elements 33. One or more (such as two) spring biasing members 35 (FIGS. 4-6) may be provided and engaged onto the pivot axles 34 respectively and engaged between or with the coupling extension 31 and the anchoring elements 33 for biasing and forcing or moving the anchoring elements 33 to the second or folding position where the anchoring elements 33 are perpendicular to the coupling extension 31.

In operation, as shown in FIGS. 5 and 7, the anchoring elements 33 may be pivoted or rotated relative to the coupling extension 31 to the first or working position where the anchoring elements 33 are in line with or parallel to the coupling extension 31 for allowing the anchoring elements 33 and the coupling extension 31 to be easily and quickly fed through the tiny space that is formed or provided beside or between the edge portion of the table plate 8 and the wall member 9 or the like. When or after the anchoring elements 33 have been moved over or beyond the table plate 8, the spring biasing members 35 may bias and force and move the anchoring elements 33 to the second or folding position where the anchoring elements 33 are perpendicular to the coupling extension 31 (FIGS. 2, 4, 6, 8), and the fastener 20 may then be rotated or driven by the screw driver tool in order to force the follower 30 to slide or move up relative to the upper surface 80 of the table plate 8 (FIG. 8) and thus to solidly and stably attach or mount or secure the follower 30 and the carrier member 10 to the table plate 8.

It is to be noted that the driver tool for engaging with and for actuating or operating or rotating or driving the fastener 20 may be arranged and located above the table plate 8 while or when the driver tool is rotated or driven or actuated or operated by the user, such that the screw clamp in accordance with the present invention may be easily actuated or operated by the user. It is further to be noted that the follower 30 itself may also be forced to slide or move up and down relative to the upper surface 80 of the table plate 8 with the fastener 20, and the carrier member 10 may be formed integral with the follower 30 for supporting the object or apparatus or facility (not illustrated), such as keyboard, monitor, displayer or the like.

It is preferable that the anchoring elements 33 each include a tilted or inclined lower or bottom surface 36 which is tilted or inclined relative to the coupling extension 31 and the pivot axles 34, and arranged for allowing the anchoring elements 33 to be pivoted or rotated relative to the coupling extension 31 to the first or working position where the anchoring elements 33 are in line with or parallel to the coupling extension 31, with or by the table plate 8 when the anchoring elements 33 and the coupling extension 31 are engaged through the tiny space that is formed or provided beside or between the edge portion of the table plate 8 and the wall member 9 or the like, and it is preferable that the anchoring elements 33 each include a flat upper surface 37 which is perpendicular to the coupling extension 31 and parallel to the follower 30 and the carrier member 10 and the table plate 8 for allowing the follower 30 to be solidly and stably anchored or retained or secured to the table plate 8 with the anchoring elements 33 and the fastener 20.

Accordingly, the screw clamp in accordance with the present invention may be easily actuated or operllated by the user, and includes an anchoring board attachable to a carrier member for allowing the carrier member to be easily and quickly engaged through a tiny space beside an edge portion of a table plate and to be easily and quickly attached and mounted to the table plate.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A screw clamp for attaching to a table plate, comprising:
a clamping device including a follower to be supported on the table plate, a coupling extension extended downwardly from said follower, and an anchoring element provided below said follower and pivotally attached to said coupling extension of said follower with a pivot axle for engaging with the table plate, said follower including a screw hole formed therein,
said anchoring element being pivotable relative to said coupling extension between a first position where said anchoring element is parallel to said coupling extension, and a second position where said anchoring element is perpendicular to said coupling extension, and
a fastener engaged with said screw hole of said follower for moving said follower up and down relative to the table plate when said fastener is rotated relative to said follower, for allowing said follower to be secured to the table plate with said fastener.

2. The screw clamp as claimed in claim 1, wherein said anchoring element includes a tilted lower surface inclined relative to said coupling extension and said pivot axle.

3. The screw clamp as claimed in claim 1, wherein said anchoring element includes a flat upper surface perpendicular to said coupling extension and parallel to said follower and the table plate.

4. The screw clamp as claimed in claim 1 further comprising a spring biasing member engaged with said coupling extension and said anchoring element for biasing and forcing said anchoring element to said second position where said anchoring element is perpendicular to said coupling extension.

5. The screw clamp as claimed in claim 1 further comprising a carrier member including a compartment formed therein, said carrier member including a through hole formed in said carrier member and communicating with said compartment of said carrier member and aligned with said screw hole of said follower for engaging with said fastener, and said carrier member including an attachment mechanism for attaching a facility.

6. The screw clamp as claimed in claim 5, wherein said compartment of said carrier member includes a non-circular cross section and opened downwardly and rearwardly, and said follower includes a non-circular cross section for being guided and limited to slide up and down relative to said compartment of said carrier member and for preventing said follower from being rotated relative to said carrier member.

7. A screw clamp for attaching to a table plate, comprising:
a clamping device including a follower to be supported on the table plate, a coupling extension extended downwardly from said follower, and two anchoring elements provided below said follower and each pivotally attached to said coupling extension of said follower with a pivot axle for engaging with the table plate, said follower including a screw hole formed therein,
said anchoring elements being pivotable relative to said coupling extension between a first position where said anchoring element is parallel to said coupling extension, and a second position where said anchoring element is perpendicular to said coupling extension, and
a fastener engaged with said screw hole of said follower for moving said follower up and down relative to the table plate when said fastener is rotated relative to said follower, for allowing said follower to be secured to the table plate with said fastener.

8. The screw clamp as claimed in claim 7, wherein said anchoring elements each include a tilted lower surface inclined relative to said coupling extension and said pivot axle.

9. The screw clamp as claimed in claim 7, wherein said anchoring elements each include a flat upper surface perpendicular to said coupling extension and parallel to said follower and the table plate.

10. The screw clamp as claimed in claim 7 further comprising a spring biasing member engaged with said coupling extension and each said anchoring element for biasing and forcing said anchoring element to said second position where said anchoring element is perpendicular to said coupling extension.

11. The screw clamp as claimed in claim 7 further comprising a carrier member including a compartment formed therein, said carrier member including a through hole formed in said carrier member and communicating with said compartment of said carrier member and aligned with said screw hole of said follower for engaging with said fastener, and said carrier member including an attachment mechanism for attaching a facility.
